(19) United States
(12) Patent Application Publication
(10) Pub. No.: US 2003/0197031 A1
(43) Pub. Date: Oct. 23, 2003

(54) Fluid dispenser pump

(75) Inventor: Ludovic Petit, Vitot (FR)

Correspondence Address: SUGHRUE MION, PLLC, 2100 PENNSYLVANIA AVENUE, N.W., WASHINGTON, DC, 20037, US

(73) Assignee: VALOIS S.A.

(21) Appl. No.: 10/414,026

(22) Filed: Apr. 16, 2003

Related U.S. Application Data
(60) Provisional application No. 60/382,047, filed on May 22, 2002.

(30) Foreign Application Priority Data
Apr. 17, 2002 (FR) 02.04813

(51) Int. Cl. B67D 5/42

(52) U.S. Cl. 222/321.9; 222/321.7

(57) ABSTRACT

A fluid dispenser pump comprising a dispenser pump (1) and a fixing element (2), said dispenser pump (1) comprising a pump body (10) containing a pump chamber (11), a piston (20) mounted to slide in said pump body (10) between a rest position and a dispensing position so as to dispense a metered quantity or “doses” of fluid each time it is actuated, said piston (20) being connected to an actuating rod (30) extending out of the pump body (10), said pump (1) being assembled in a fixing element (2), such as a fixing ring or cap, serving to fix the pump (1) to a fluid reservoir, a sealing gasket (50) being interposed between said pump body (10) and said fixing element (2), said pump being characterized in that said sealing gasket (50) is in continuous leaktight contact with said actuating rod (30), which slides in leaktight manner against said sealing gasket (50) while the pump (1) is being actuated and which rests in leaktight manner against said sealing gasket (50) when the pump is in the rest position (1).

### CROSS REFERENCE TO RELATED APPLICATION

This application claims the benefit under 35 U.S.C. §119(e) of pending U.S. provisional patent application Serial No. 60/382,047, filed May 22, 2002, and priority under 35 U.S.C. §119(a)-(d) of French patent application No. FR-02.04813, filed Apr. 17, 2002.

### TECHNICAL FIELD

The present invention relates to a fluid dispenser pump, and to a fluid dispenser device including such a pump. More particularly, the present invention is applicable to dispenser devices in which the fluid is kept without any preservative, so that it is important to remove any risk of said fluid being contaminated while the device is being stored and/or while it is being used.

### BACKGROUND OF THE INVENTION

Such preservative-free dispenser devices are well known, and they fall into two distinct categories. Firstly, there are “airless” devices with no air intake, in which the fluid is generally kept in a flexible reservoir whose volume decreases as the fluid is dispensed. Secondly, there are devices with air intakes, in which case the air taken into the device or the pump must be filtered to prevent any bacteria, germs, or other elements that are harmful to the fluid from entering it. Document FR-2 798 368 discloses such a pump and such a device.

Unfortunately, it has been observed that bacteria or germs can enter the device via a path other than the intake air path, in which a filter is generally provided. Thus, in most pumps, and in particular the pump disclosed in FR-2 798 368, the actuating rod is mounted to slide against an element of the pump (generally a ferrule) used to define the rest position for the pump. That contact between the actuating rod and the ferrule is not necessarily leaktight, since the sealing of the pump is provided at the piston, which is secured to or integral with the actuating rod. In some cases, it is possible that germs or bacteria might penetrate into the pump through that route, i.e. via the interface between the ferrule and the actuating rod. When the pump is in the rest position, the piston of the pump forms a leaktight seal with the bottom end of the ferrule, but when the pump is in the actuating position, that seal no longer exists, so that, during actuation, any germs or bacteria can penetrate more deeply into the pump body, so that they can ultimately come into contact with the fluid contained in the pump chamber.

### BRIEF SUMMARY OF THE INVENTION

An object of the present invention is to provide a fluid dispenser pump that does not suffer from the above-mentioned drawbacks.

More particularly, an object of the present invention is to provide such a pump that is effective in preventing germs or bacteria from entering it.

A further object of the present invention is to provide such a pump that is simple and inexpensive to manufacture and to assemble.

The present invention thus provides a fluid dispenser pump comprising a dispenser pump and a fixing element, said dispenser pump comprising a pump body containing a pump chamber, a piston mounted to slide in said pump body between a rest position and a dispensing position so as to dispense a metered quantity or “dose” of fluid each time it is actuated, said piston being connected to an actuating rod extending out of the pump body, said pump being assembled in a fixing element, such as a fixing ring or cap, serving to fix the pump to a fluid reservoir, a sealing gasket being interposed between said pump body and said fixing element, said pump being characterized in that said sealing gasket is in continuous leaktight contact with said actuating rod, which slides in leaktight manner against said sealing gasket while the pump is being actuated and which rests in leaktight manner against said sealing gasket when the pump is in the rest position.

Advantageously, the pump further comprises a ferrule assembled in the pump body to define the rest position for the piston, said gasket being assembled on said ferrule.

Advantageously, a filter for air taken into the pump is associated with said sealing gasket.

Advantageously, the actuating rod is provided with a flexible outer tube against which said sealing gasket rests.

The present invention also provides a fluid dispenser device including a pump as defined above.

### BRIEF DESCRIPTION OF THE DRAWINGS

The advantages and characteristics of the present invention will appear more clearly on reading the following detailed description of an embodiment of it, given with reference to the accompanying drawing which is given by way of non-limiting example, and in which:

FIG. 1 is a diagrammatic section view of a fluid dispenser pump 1 of the present invention; and

FIG. 2 is an enlarged diagrammatic view of a detail of FIG. 1.

### DETAILED DESCRIPTION

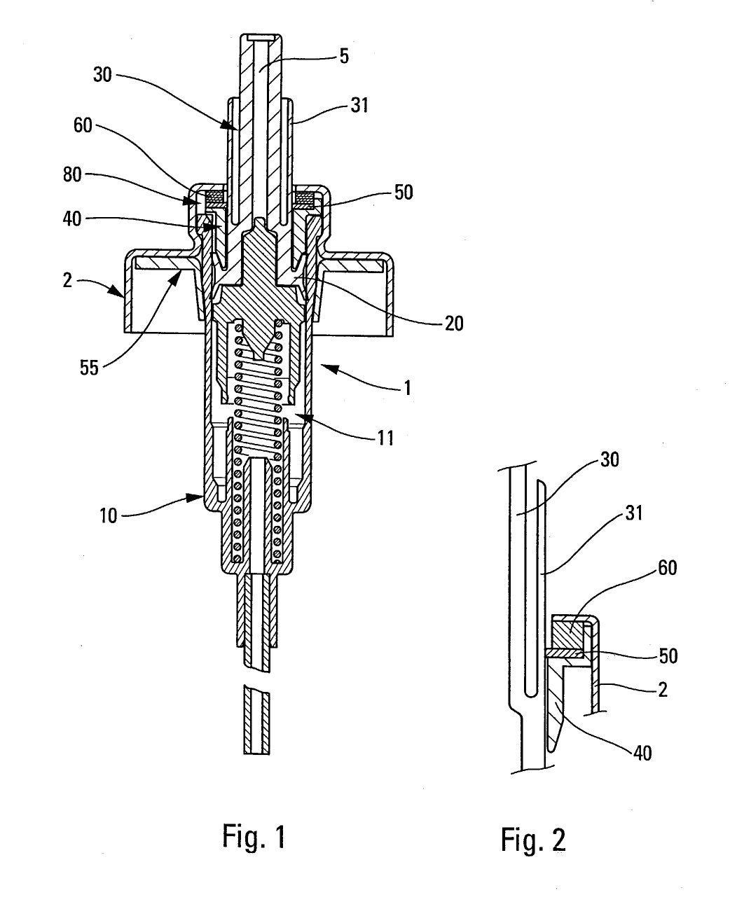

With reference to FIG. 1, the fluid dispenser pump 1 includes a pump body 10 in which a piston 20 is mounted to slide in leaktight manner. The piston 20 is connected to an actuating rod 30, the piston advantageously being integral with the rod. The pump body 10 is generally assembled onto the neck of a reservoir (not shown) by means of a fixing element 2, such as a ring or a cap, which may be of arbitrary type, and in particular snap-fastenable, screw-fastenable, or crimpable. Sealing between the pump 1 and the fixing element 2 is provided by means of an annular gasket 50, and sealing between the fixing element 2 and the reservoir (not shown) is provided by means of a neck gasket 55. The pump 1 may be pre-assembled in the fixing element 2 to form a dispenser assembly.

In the invention, the sealing gasket 50 is in continuous leaktight contact with the actuating rod 30. Thus, the actuating rod 30 rests in leaktight manner against said sealing gasket 50 when the pump is in the rest position (shown in FIG. 1), and slides in leaktight manner against said sealing gasket 50 while the pump is being actuated. This implementation guarantees that the contact between the pump and the actuating rod 30 is leaktight so that it is impermeable to the fluid, to air, and to bacteria or germs. It is therefore impossible for germs or bacteria to penetrate into the pump 1.

In the embodiment shown in the figures, the pump 1 includes a ferrule 40 which is assembled in the pump body 10, in particular at the top edge of said body, to define the rest position for the pump. In which case, the gasket 50 may be assembled onto said ferrule 40.

In known manner, a filter 60 for air taken into the pump 1 may be associated with the sealing gasket 50, and in particular may be disposed in the vicinity or against said gasket. In a variant, the gasket 50 and the filter 60 may be made in the form of a single piece that is impermeable to the fluid but that is permeable to the intake air, while filtering said intake air to prevent any germs or bacteria from penetrating into the pump 1 via the intake passageway. As shown in FIG. 1, the intake passageway 80 may be defined between the fixing element 2 and the outside of the ferrule 40, but other implementations for the intake passageway, and some other positioning for the filter 60 may be devised.

Advantageously, as shown in the figures, the actuating rod 30 incorporates a relatively flexible outer tube 31 against which said sealing gasket 50 rests and slides. This implementation guarantees that leaktightness is maintained even if the force exerted by the user on the actuating rod 30 is not exactly axial. This further removes the risk of germs or bacteria penetrating into the pump while said pump is being actuated.

The present invention thus provides a fluid dispenser pump that prevents any germs or bacteria from entering into the pump, while said pump is at rest and while it is being actuated, so that it is particularly well suited to being used with a fluid dispenser device in which the fluid is kept without any preservative.

Although the present invention is described with reference to a particular embodiment of it, it should be understood that any modification may be made to it by the person skilled in the art without going beyond the ambit of the present invention as defined by the accompanying claims.

What is claimed is:

1/ A fluid dispenser pump comprising a dispenser pump (1) and a fixing element (2), said dispenser pump (1) comprising a pump body (10) containing a pump chamber (11), a piston (20) mounted to slide in said pump body (10) between a rest position and a dispensing position so as to dispense a metered quantity or “dose” of fluid each time it is actuated, said piston (20) being connected to an actuating rod (30) extending out of the pump body (10), said pump (1) being assembled in a fixing element (2), such as a fixing ring or cap, serving to fix the pump (1) to a fluid reservoir, a sealing gasket (50) being interposed between said pump body (10) and said fixing element (2), said pump being characterized in that said sealing gasket (50) is in continuous leaktight contact with said actuating rod (30), which slides in leaktight manner against said sealing gasket (50) while the pump (1) is being actuated and which rests in leaktight manner against said sealing gasket (50) when the pump is in the rest position (1).

2/ A pump according to claim 1 or claim 2, further comprising a ferrule (40) assembled in the pump body (10) to define the rest position for the piston (20), said gasket (50) being assembled on said ferrule (40).

3/ A pump according to claim 1 or 2, in which a filter (60) for air used to ventilate the pump (1) is associated with said sealing gasket (50).

4/ A pump according to any preceding claim, in which the actuating rod (30) is provided with a flexible outer tube (31) against which said sealing gasket (50) rests.

5/ A fluid dispenser device, characterized in that it includes a pump according to any preceding claim.
